(19) United States
(12) Patent Application Publication
(10) Pub. No.: US 2013/0085868 A1
(43) Pub. Date: Apr. 4, 2013

(54) SYSTEM AND METHOD FOR GENERATING AN EFFECTIVE BID PER IMPRESSION BASED ON MULTIPLE ATTRIBUTION OF PAY-PER-CONVERSION ADVERTISING

(71) Applicants: Patrick Jordan, Mountain View, CA (US); Mohammad Mahdian, Santa Clara, CA (US); Sergey Vassilvitskii, New York, NY (US); Erik Vee, San Mateo, CA (US)

(72) Inventors: Patrick Jordan, Mountain View, CA (US); Mohammad Mahdian, Santa Clara, CA (US); Sergey Vassilvitskii, New York, NY (US); Erik Vee, San Mateo, CA (US)

(21) Appl. No.: 13/251,938

(22) Filed: Oct. 3, 2011

(51) Int. Cl. G06Q 30/02

(52) U.S. Cl. 705/14.71

(57) ABSTRACT

A system and method for calculating an effective bid per impression are disclosed. The system and method may receive a price per conversion bid of an advertiser and information from at least one user. The information may comprise a user state of the user. In some embodiments, the user state may comprise a number of times that the user has previously viewed the advertisement. The user state may be input into a user behavioral model to determine predictive values of the user behavior. An effective bid per impression may then be calculated based on the predictive values of the user and the advertiser's bid per conversion.

### FIELD

The present disclosure relates to a system and method for generating an effective bid per impression. In some embodiments, the present disclosure relates to a system and method for generating an effective bid per impression based on multiple attribution of pay-per-conversion advertising.

### BACKGROUND

The Internet is a ubiquitous medium of communication in most parts of the world. The emergence of the Internet has opened a new forum for the creation and placement of advertisements promoting products, services, and brands. Internet content providers rely on advertising revenue to drive the production of free or low cost content. Advertisers, in turn, increasingly view Internet content portals and online publications as a critically important medium for the placement of advertisements.

The interactive nature of Internet communication enables advertisers and content providers to target advertising campaigns to viewers. Advertisers may pay for the display of an advertisement to a viewer. For example, an advertiser may pay for each advertisement impression on a web page, a user clicking on an advertisement, or for a conversion of a product or service associated with the advertisement. In the context of an advertiser paying for a conversion associated with an advertisement, traditional user models may be used to convert the advertiser's price per conversion to a value per impression of the advertisement. However, such traditional user models assume that each impression of the advertisement leads to a conversion independent of other impressions of the same advertisement.

As such, it is desirable to develop systems and methods of generating an effective bid per impression for an advertiser. The effective bid per impression may address multiple attribution scenarios where a sequence of advertisement impressions may contribute towards a conversion of the advertisement.

### SUMMARY

The present disclosure introduces systems and methods for generating an effective bid per impression based on multiple attribution of pay-per-conversion advertising.

The system or method may calculate a bid price for an advertiser to display an advertisement to a user on a website. The system or method may receive an advertising bid from the advertiser. In some embodiments, the advertising bid may comprise a price per conversion bid for displaying the advertisement on a website. A user state of a user may be received. In some embodiments, the user state may comprise a number of times that the user has previously viewed the advertisement. At least one predictive value of the user may be determined by using a user behavior model with the user state as an input. The predictive value may comprise at least one probability of how the user will respond to the advertisement if the advertisement is displayed. An effective bid per impression may then be calculated based on the predictive value of the user and the price per conversion bid for the advertisement from the advertiser.

In some embodiments, user state further comprises an identification of the publisher of the website and a weighted value assigned to the publisher of the website such that a higher weighted value results in a higher predictive value than a lower weighted value. In the same or alternative embodiments, the user state may further comprise demographic information of the user and geographical information of the user.

In some embodiments, the probability of how the user will respond to the advertisement comprises a likelihood of the user transitioning to a state comprising at least one of a quit state and a conversion state, the quit state comprising a terminal state where the user will not convert with regard to the advertisement and the conversion state comprising a terminal state where the user will convert with regard to the advertisement. In the same or alternative embodiments, likelihood of the user transitioning to a state further comprises an intermediary state of displaying the advertisement to the user at another time and determining a probability of the user transitioning from the intermediary state to the conversion state.

In some embodiments, the user state further comprises a path of the user where the path may comprise online behavior of the user. In the same or alternative embodiments, the system or method may further submit the calculated effective bid per impression on behalf of the advertiser to a publisher of the website.

### BRIEF DESCRIPTION OF THE DRAWINGS

The novel features of the disclosure are set forth in the appended claims. However, for purpose of explanation, several embodiments of the disclosure are set forth in the following figures.

FIG. 1 is a flow diagram of an example method of an advertising bidding process in accordance with some embodiments.

FIG. 2 is an example embodiment of an online advertising system in accordance with some embodiments.

FIG. 3 depicts a diagram illustrating an advertisement delivery system within which some embodiments of the disclosure are implemented.

FIG. 4 depicts a diagram illustrating an advertisement delivery system within which some embodiments of the disclosure are implemented

FIG. 5 is a flow diagram of a method for bidding with an effective bid per impression in accordance with some embodiments.

FIG. 6 is a flow diagram of an example method for calculating an effective bid per impression.

FIG. 7 illustrates a plurality of user states and transitions between the user states in accordance with some embodiments.

FIG. 8 depicts a diagram illustrating an exemplary computing system for execution of the operations comprising various embodiments of the disclosure.

### DETAILED DESCRIPTION

The systems and methods disclosed herein relate to generating an effective bid per impression based on multiple attribution of pay-per-conversion advertising

In the following detailed description, numerous specific details are set forth in order to provide a thorough understanding of the present disclosure. However, it will become obvious to those skilled in the art that the present disclosure may be practiced without these specific details. The description and representation herein are the common means used by those experienced or skilled in the art to most effectively convey the substance of their work to others skilled in the art. In other instances, well known methods, procedures, and systems have not been described in detail to avoid unnecessarily obscuring aspects of the present disclosure.

The disclosure that follows is divided into four sections. Section I contains terms used herein. Section II describes an online advertisement delivery system environment. Section III describes systems and methods for calculating an effective bid per impression. Section IV describes pricing and publisher fairness.

I. Terms

Some of the terms used in the disclosure are defined below in alphabetical order. These terms are not rigidly restricted to these definitions. A term may be further defined by the term's use in other sections of the disclosure.

“Ad” (e.g., advertisement, item and/or message) may refer to a paid announcement, as of goods or services for sale, preferably on a network (e.g., the Internet). An ad may also be referred to as an ad, advertisement, an item and/or a message.

“Ad call” may refer to a message sent by a computer to an ad server for requesting an ad to be displayed. An “ad call” may be referred to as an “advertisement call.”

“Ad click-through rate” (e.g. click-through rate or “CTR”) may refer to the ratio of advertisement clicks over advertisement impressions.

“Ad code” may refer to the HyperText Markup Language (HTML) or other markup language description that describes an advertisement or message in such a manner as can be parsed by a browser. Ad code may include references to another ad code(s). Ad code may mean any subset, or portion or segment of ad code that describes an advertisement or message in such a manner as can be parsed by a browser.

“Ad server” may refer to a server that is configured for serving one or more ads to user devices. An ad server may be controlled by a publisher of a website and/or an advertiser of online ads. A server is defined below.

“Advertiser” (e.g. messenger and/or messaging customer, etc.) may refer to an entity that is in the business of marketing a product and/or a service to users. An advertiser may include, without limitation, a seller and/or a third-party agent for the seller. An advertiser may also be referred to as a messenger and/or a messaging customer. Advertising may also be referred to as messaging.

“Advertising” may refer to marketing a product and/or service to one or more potential consumers by using an advertisement. An example of advertising may comprise publishing a sponsored search ad on a website.

“Application server” may refer to a server that is configured for running one or more devices loaded on the application server. For example, an application server may run a device configured for deducing shadow profiles.

“Click” (e.g. ad click) may refer to a selection of an ad impression by using a selection device such as, for example, a computer mouse or a touch-sensitive display.

“Client” may refer to the client part of client-server architecture. A client may comprise a user device and/or an application that runs on a user device. A client may rely on a server to perform operations. For example, an email client is an application that enables a user to send and receive email via an email server. As such, the computer running such an email client may also be referred to as a client.

“Conversion” (e.g. ad conversion) may refer to a purchase of a product and/or service that occurs as a result of a user responding to an advertisement and/or a coupon.

“Database” (e.g. database system, etc.) may refer to a collection of data organized in such a way that a computer program may quickly select desired pieces of the data. A database may be an electronic filing system. In some instances, the term “database” may be used as shorthand for a “database management system.” A database may be implemented as any type of data storage structure capable of providing for the retrieval and storage of a variety of data types. For example, a database may comprise one or more accessible memory structures such as a CD-ROM, tape, digital storage library, flash drive, floppy disk, optical disk, magnetic-optical disk, erasable programmable read-only memory (EPROM), random access memory (RAM), magnetic or optical cards, etc.

“Device” may refer to hardware, software or a combination thereof. A device may sometimes be referred to as an apparatus. Examples of a device include, without limitation, a software application such as Microsoft Word™ or a database, or hardware such as a laptop computer, a server, a display, or a computer mouse and/or a hard disk.

“Impression” (e.g. ad impression) may refer to a delivery of an advertisement to a user device for viewing by a user.

“Item” may refer to an ad, which is defined above.

“Marketplace” may refer to a world of commercial activity where products and/or services are browsed, bought and/or sold, etc. A marketplace may be located over a network, such as the Internet. A marketplace may also be located in a physical environment, such as a shopping mall.

“Message” may refer to an ad, which is defined above.

“Messaging” may refer to advertising, which is defined above.

“Messenger” may refer to an advertiser, which is defined above.

“Network” may refer to a connection, between any two or more computers, that permits the transmission of data. A network may be any combination of networks including, without limitation, the Internet, a local area network, a wide area network, a wireless network, and/or a cellular network.

“Publisher” may refer to an entity that publishes, on a network, a web page having content and/or ads, etc.

“Server” may refer to a software application that provides services to other computer programs (and their users), on the same computer or on another computer or computers. A server may also refer to the physical computer that has been set aside to run a specific server application. For example, when the software Apache HTTP Server is used as the web server for a company's website, the computer running Apache may also be called the web server. Server applications may be divided among server computers over an extreme range, depending upon the workload.

“Slate” (e.g., ad slate) may refer to the ordered list of ads returned by a server in response to a query.

“Software” may refer to a computer program that is written in a programming language that may be used by one of ordinary skill in the art. The programming language chosen should be compatible with the computer on which the software application is to be executed and, in particular, with the operating system of that computer. Examples of suitable programming languages include, without limitation, Object Pascal, C, C++ and/or Java. Further, the functions of some embodiments, when described as a series of steps for a method, could be implemented as a series of software instructions for being operated by a processor such that the embodiments could be implemented as software, hardware, or a combination thereof. Computer-readable media are discussed in more detail in a separate section below.

“System” may refer to a device or multiple coupled devices. A device is defined above.

“User” (e.g. consumer, etc.) may refer to an operator of a user device. A user may be a person who seeks to acquire a product and/or service. For example, a user may be a woman who is browsing Yahoo!™ Shopping for a new cell phone to replace her current cell phone. The term “user” may also refer to a user device, depending on the context.

“User device” (e.g. computer, user computer, client and/or server, etc.) may refer to a single computer or a network of interacting computers. A user device is a computer that a user may use to communicate with other devices over a network, such as the Internet. A user device may comprise a combination of a hardware system, a software operating system, and one or more software application programs. Examples of a user device include, without limitation, a laptop computer, a palmtop computer, a smart phone, a cell phone, a mobile phone, an IBM-type personal computer (PC) having an operating system such as Microsoft Windows™, an Apple™computer having an operating system such as MAC-OS, hardware having a JAVA-OS operating system, and/or a Sun Microsystems™ workstation having a UNIX operating system.

“Web browser” may refer to a software program that may display text or graphics or both, from web pages on websites. Examples of a web browser include, without limitation, Mozilla Firefox™ and Microsoft Internet Explorer™.

“Web page” may refer to documents written in a mark-up language including, without limitation, HTML (hypertext mark-up language), VRML (virtual reality modeling language), dynamic HTML, XML (extensible mark-up language), and/or other related computer languages. A web page may also refer to a collection of such documents reachable through one specific Internet address and/or through one specific website. A web page may also refer to any document obtainable through a particular URL (uniform resource locator).

“Web portal” (e.g. public portal) may refer to a website or service that offers a broad array of resources and services such as, for example, email, forums, search engines, and online shopping malls.

“Web server” may refer to a server configured for serving at least one web page to a web browser. An example of a web server is a Yahoo!™ web server. A server is defined above.

“Website” may refer to one or more web pages. A website preferably includes a plurality of web pages virtually connected to form a coherent group.

II. Online Advertisement Delivery System Environment

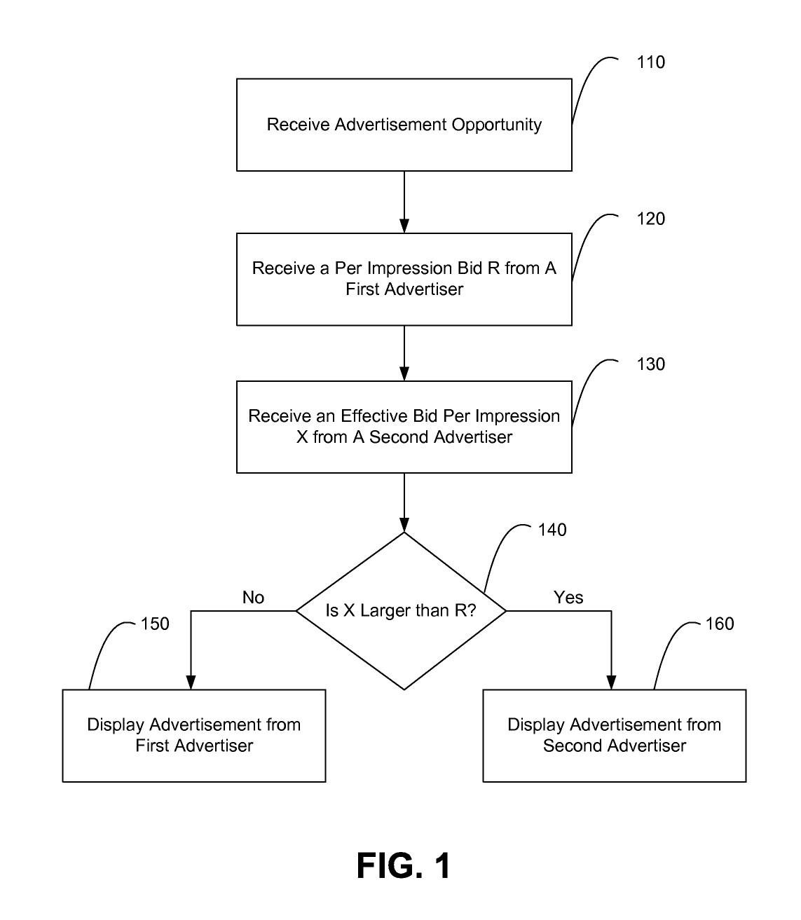

FIG. 1 is a flow diagram of an example method 100 of an advertisement bidding process in accordance with some embodiments. In general, the method 100 receives a plurality of bids for an advertisement opportunity and displays an advertisement corresponding to one of the received bids.

As seen in FIG. 1, at block 100, an advertisement opportunity may be received or identified. For example, the advertisement opportunity may comprise an available advertisement inventory location on a website for displaying an advertisement. At block 120, a bid R from a first advertiser may be received. For example, in some embodiments, the bid from the first advertiser may comprise a per-impression bid price (e.g., an amount for each display of the advertisement from the first advertiser). At block 130, an effective bid per impression X from a second advertiser may be received. In some embodiments, the effective bid per impression may be calculated based on the second advertiser's price per conversion and a user state, as discussed in further detail with regard to Section III. As such, an effective bid per impression may be calculated for a second advertiser and used to bid on behalf of the second advertiser. At block 140, a determination is made whether the bid from the second advertiser (e.g., X) is larger than the bid from the first advertiser (e.g., R). If a determination is made that the bid from the first advertiser is larger than the bid from the second advertiser, then, at block 150, an advertisement from the first advertiser may be displayed. If a determination is made that the bid from the second advertiser is larger than the bid from the first advertiser, then, at block 160, an advertisement from the second advertiser may be displayed.

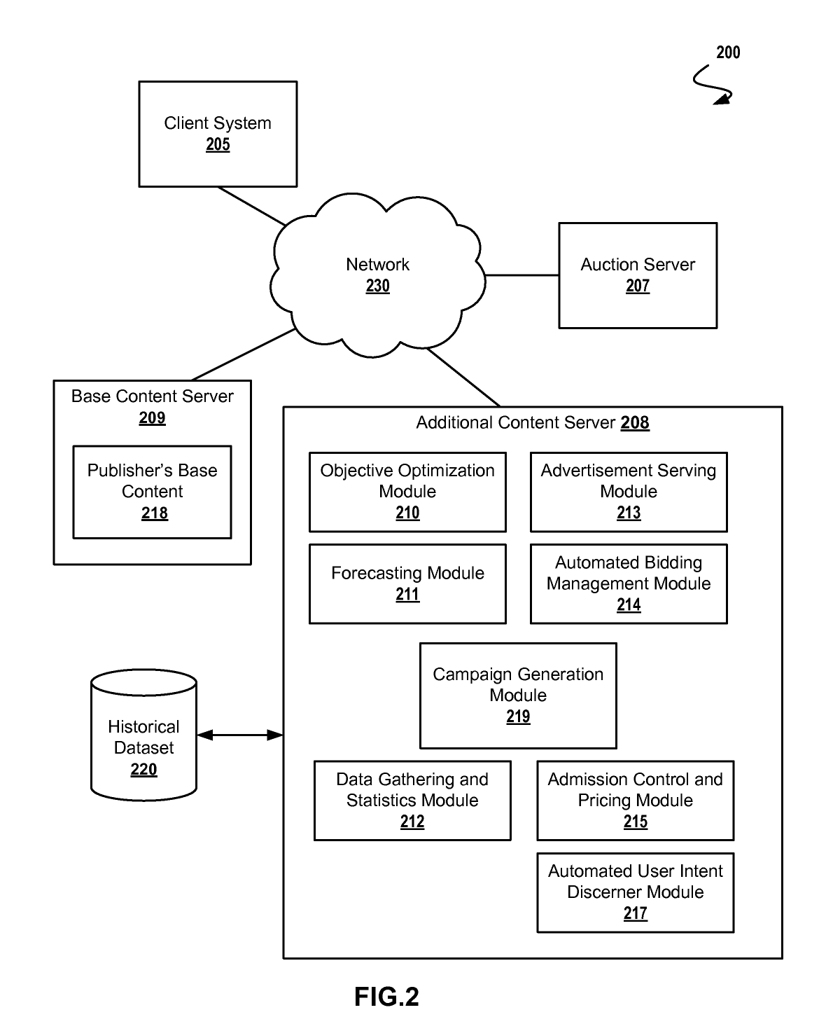

FIG. 2 is an example of an online advertising system environment 200. In some embodiments, the method 100 of an advertisement bidding process as described with relation to FIG. 1 may be used in conjunction with the online advertising system environment 200. In the context of online (e.g., Internet) advertising, placement of advertisements within a web page may use the online advertising system environment 200. An internet advertiser or agent may select a particular online property (e.g., a webpage or website), and may create an advertisement such that whenever any online user, via a client system 205, renders a web page from the selected property, the advertisement (e.g., a creative) is composited or inserted on the web page by one or more servers (e.g., a base content server 209 and/or an additional content server 208) for delivery to a client system 205 over a network 230. Using such a delivery model and the systems and methods disclosed herein, sophisticated advertising techniques may be practiced.

As seen in FIG. 2, an online (e.g., Internet) property (e.g., a publisher hosting the publisher's base content 218 on a base content server 209) may measure the characteristics of visitors (where visitors may have any arbitrary interest, demographic, target predicates, or other attributes) using an additional content server 208 in conjunction with a data gathering and statistics module 212, and using a historical dataset 220 as pertains to user behavior that has been observed. Thus, an online user's demographics and interest might be ‘known’ in quite some detail as it pertains to a wide range of user queries, interest categories, or other demographics or attributes. Also, behaviors (e.g., the likelihood of a click or other measurable event) might be known in quite some detail, not only for a particular user, but also for a group of users corresponding to a particular subset of the available data. Such characteristics (i.e., one or more characteristics) and/or features (i.e., one or more features) can be used in statistical modeling of users. That is, a given model can predict the likelihood p of a click c based on a feature set, and thus, a given model can be used to calculate probability p(c|x), that quantity being the probability of a user click response based on the constituents of x. Similarly, a likelihood of a user converting with regard to an advertisement may also be predicted, as discussed in further detail below.

Such characteristics (i.e., one or more characteristics) and/or features can be used in the statistical modeling of users, even to the extent that a forecasting module 211, possibly in conjunction with a data gathering and statistics module 212 can forecast future supply accurately—at least to a statistically known degree.

In some embodiments, the online advertising system 200 might host a variety of modules to serve management and control operations (e.g., an objective optimization module 210, a forecasting module 211, a data gathering and statistics module 212, an advertisement serving module 213, an automated bidding management module 214, an admission control and pricing module 215, etc.) pertinent to aiding advertisers in defining effective sponsored search advertising campaigns and for serving advertisements to users. In particular, the modules, network links, algorithms, forecasting techniques, serving policies, and data structures embodied within the online advertising system 200 might be specialized so as to perform a particular function or group of functions reliably while observing capacity and performance requirements. For example, a campaign generation module 219 and/or an automated user intent discerner module 217 can operate partly in an offline (or batch) mode and partly in an online (or interactive) mode. Further, a database for storing the historical dataset 220 (which can also store historical click data and/or forecasted data) can operate in an online mode or in an offline mode, or both. As shown, and without regard to allocation of any particular operation to any particular mode, an auction server 207, and an automated user intent discerner module 217.

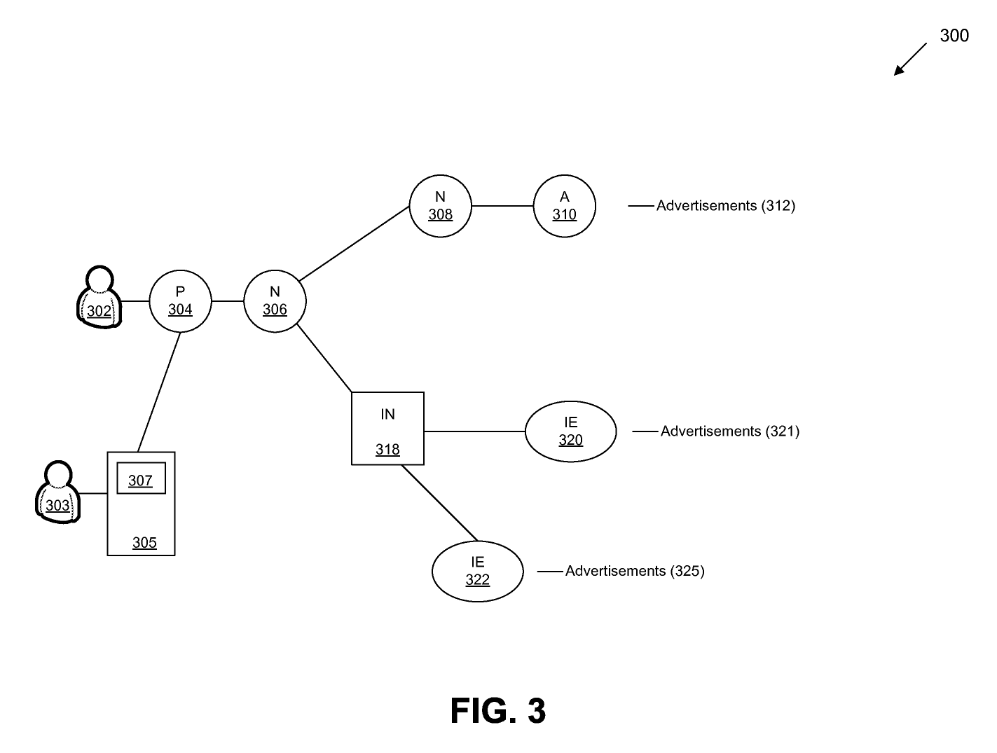

FIG. 3 illustrates an advertisement delivery system environment 300 within which some embodiments of the disclosure are implemented. In general, the embodiments described herein may be implemented as part of an advertising exchange service. An advertising exchange service may integrate entities, such as advertisers and publishers. An advertising exchange service may operate in conjunction with advertisers and publishers in order to deliver advertisements, from one or more advertisers, to web pages of one or more publishers. For example, Yahoo!™, the assignee of the present disclosure operates such an advertising exchange service.

An integrator network entity may define a participant of the advertising exchange system that represents or integrates one or more entities on the advertising exchange system (e.g., advertisers, publishers, advertising networks, etc.). For example, an integrator network may represent advertisers on the advertising exchange system in order to deliver advertisements to publishers, advertising networks and other integrator networks. In some embodiments, the integrator networks are referred to as the “users” of the advertising exchange system. The integrated networks may comprise third party agents that operate on behalf of or are part of the integrator network. The term “third party agent” may be used to generally describe an agent or customer that participates in transactions on the advertising exchange system. Similarly, the term “third party recipient” may be used to describe a user or participant of the advertising exchange system that receives information from the system, such as bid requests. However, the terms integrator networks, third party agents and third party recipients may be intended to represent a broad class of entities, including publishers, advertisers and networks, as well as the agents that represent them, that operate on the advertising exchange system.

As shown in FIG. 3, the system 300 includes a plurality of entities end users 302 and 303, one or more publishers 304, networks 306 and 308, and/or advertisers 310. The advertisement delivery system 300 further includes one or more integrator networks (IN) 318 that have one or more integrated entities (IE) 320 and 322. The various entities, including users, publishers, networks, advertisers, integrator networks and integrated entities, illustrated in FIG. 3 are merely exemplary, and one of ordinary skill recognizes that the system 300 may include any number of entities. Moreover, the various entities are coupled together in different advantageous configurations such as, for example, the exemplary configuration as seen in FIG. 3.

The user 303 may access information and/or content provided by the publisher 304. For example, a user accessing information and/or content may comprise a browser 305 displaying a web page comprising inventory location(s) 307 for the presentation of advertisement(s). In some embodiments, an advertisement call is generated that requests an advertisement, from advertisements or advertisers 312, 320 and 321, for placement with the inventory location 307. The corresponding advertisement may be delivered to publisher 304 by one or more networks. In some embodiments, the network 306 may be coupled to the publisher 304 and the network 308 may be coupled to the advertiser 310. As such, the networks 306 and 308 are coupled to each other. The advertiser 310 may have one or more advertisement campaigns such that each advertisement campaign comprises one or more advertisements 312 that the advertiser 310 wishes to place with the inventory of publishers such as, for example, the inventory location 307 of the publisher 304 that may be presented to the user 303 via the browser application 305.

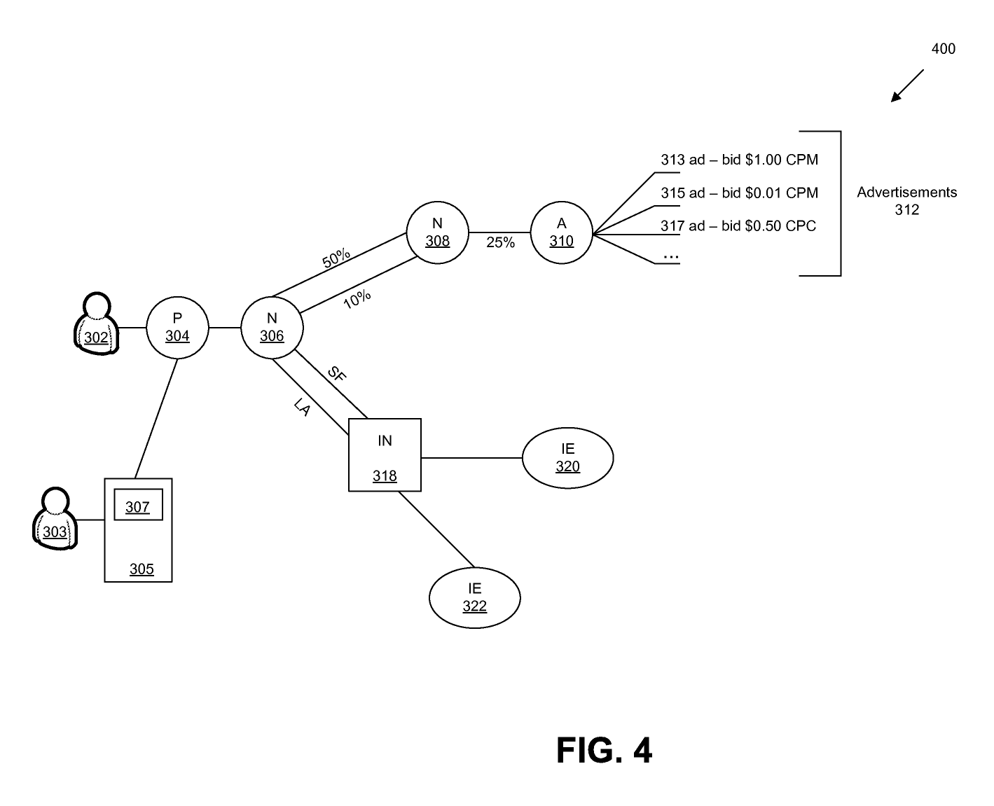

FIG. 4 is another example of an advertisement delivery system 300. In this example, the advertisements 313, 315, and 317 each may have an associated bid that the advertiser 310 will pay for the placement of the advertisement with the inventory and for presentation to the user(s). The advertisement 313 may have a bid of $1.00 cost per thousand page impressions (“CPM”), the advertisement 315 may have a bid of $0.01 CPM, and the advertisement 316 may have a bid of $0.50 cost per click (“CPC”). One of ordinary skill in the art would recognize that any different type of advertisement bid may be used in the advertisement delivery system 300. Examples of bids include, but are not limited to, CPM, CPC, and cost per action (“CPA”). In some embodiments, the advertisement delivery system 300 may normalize the advertisement bids to an effective bid per impression, as disclosed with relation to Section III of the present disclosure.

As seen in FIG. 4, the entities along the chain of distribution for the advertisements have various revenue sharing agreements. For example, the network 308 may have a 25% revenue sharing agreement with the network 306 for fees paid by the advertiser 310. Similarly, the network 306 may have 50% and 10% revenue sharing agreements with the publisher 304 for fees paid to the network 306 by way of the network 308. The multiple revenue sharing agreements between entities may be for different advertisement campaigns and/or for targeting advertisements to different segments of users (e.g., groups of users). For example, the 50% revenue sharing agreement between networks 308 and 306 may be used to target a user segment that comprises males under 40 years old who have an interest in sports. In some embodiments, the 10% revenue sharing agreement may be used to target females over 30 years old who have an interest in gardening. As such, network 308 may deliver users of the target user segment to network 306, and network 306 is the exclusive representative of the publisher 304. One of ordinary skill in the art recognizes many different payment and/or targeting schemes.

In the same or alternative embodiments, an advertisement call for the inventory 307 may be directed to an integrator network 318. For example, the advertisement call may passed from the network 306 to the integrator network 318 with additional information. In some embodiments, the additional information may comprise a geographic location for the destination of the advertisement. For example, an advertisement call may have a destination of San Francisco (SF), while a second advertisement call may have a destination of Los Angeles (LA). Based on the advertisement call and/or information, the integrator network 318 may selectively respond to advertisement calls for, or on behalf of, one or more of its integrated entities 320 and/or 322. The integrated entities 320 and 322 may include third party entities, such as advertisers, that transact on the exchange by using an intermediary, such as the integrator network 318.

III. Calculating an Effective Bid Per Impression

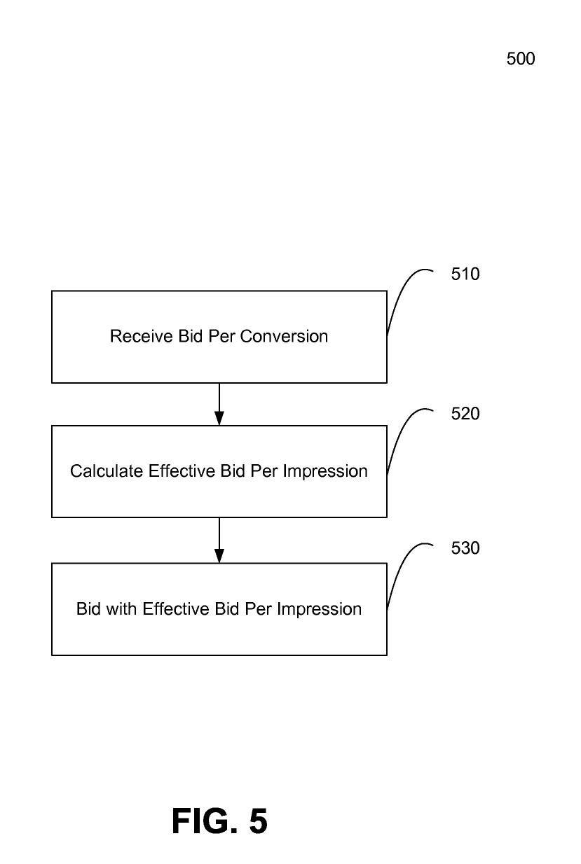

FIG. 5 is a flow diagram of a method 500 for bidding with an effective bid per impression. In general, the method 500 may be used in an online advertisement delivery system environment as discussed above. In general, the method 500 may submit an effective bid-per-impression on behalf of an advertiser.

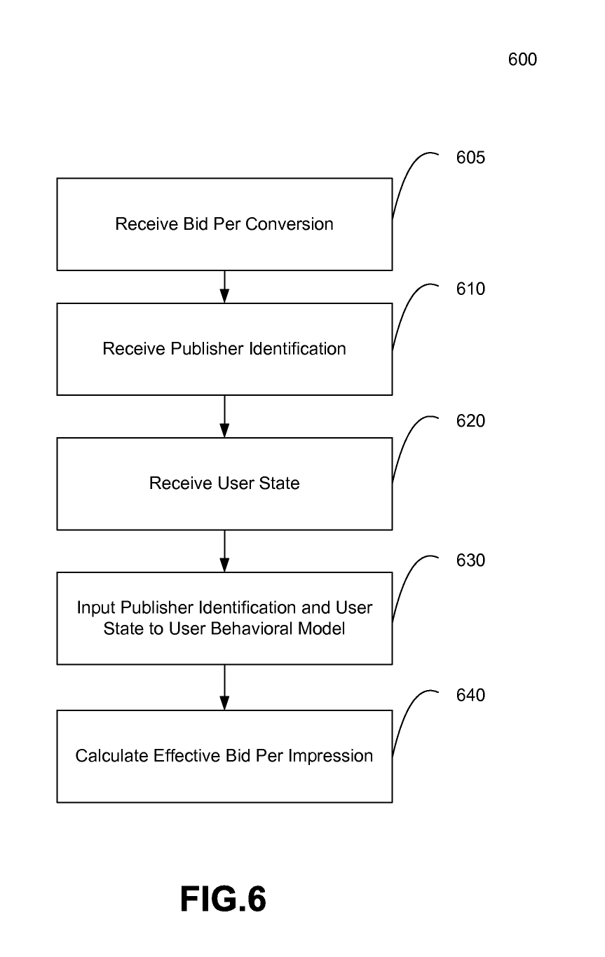

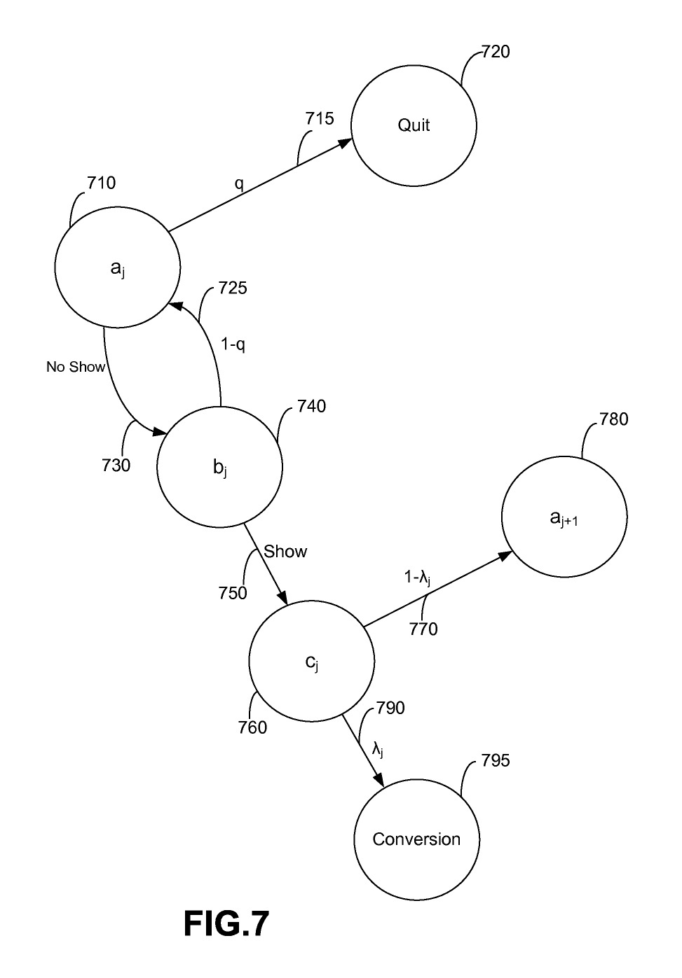

As seen in FIG. 5, at block 510, a bid-per-conversion may be received from an advertiser. At block 520, an effective bid-per-impression may be calculated. For example, the advertiser's bid-per-conversion may be converted to a calculated effective-bid-per impression for the advertiser. Further details with regard to the calculation of an effective bid-per-impression are discussed with relation to FIGS. 6 and 7. At block 530, the effective bid-per-impression may be submitted as a bid on behalf of the advertiser as previously discussed with relation to the advertisement delivery systems of FIGS. 2, 3, and 4.

FIG. 6 is a flow diagram of a method 600 for calculating an effective bid per impression. In general, the method 600 receives a bid per conversion of an advertiser and converts the bid per conversion to an effective bid per impression.

As seen in FIG. 6, the method 600 receives, at block 605, a bid per conversion of an advertisement from an advertiser. In some embodiments, the bid per conversion may comprise a specified amount an advertiser is willing to pay for a conversion (e.g., a purchase) of a product or service associated with the advertisement. For example, the bid per conversion may be specified at $0.50 for each conversion associated with an advertisement displayed to a user on a web page. At block 610, a publisher (e.g., a provider of web page content) identification may be received. In some embodiments, the publisher identification may identify or specify a publisher (e.g., a website or web page) with an advertisement inventory location for displaying an advertisement from an advertiser. As such, the publisher identification may specify the current publisher offering to display the advertisement.

At block 620 of FIG. 6, a user state may be received. In some embodiments, a user state may comprise a number of impressions of the advertisement that a user has viewed. For example, the user state may specify that the user has seen the advertisement three previous times and, as such, a next display of the advertisement to the user will be a fourth time that the user has viewed the advertisement. In the same or alternative embodiments, the user state may comprise a path of the user. For example, the user state may comprise user behavior. As such, the user state may comprise a behavioral history of the user (e.g., any or all of how many web pages the user has visited, how long the user has spent on a web page, links that the user has clicked on, whether the user is a registered user of a website, the number of times that the user has viewed a particular advertisement, whether the user has clicked on an advertisement, whether the user has converted with regard to a product or service associated with a viewed advertisement, etc.). In some embodiments, the user state may comprise user demographic information (e.g., age, gender, interests) and/or geographical information (e.g., information obtained from the user's Internet Protocol (IP) address or information from a user's registered profile). The user path may comprise particular publishers (e.g., websites) that the user has visited and which publishers displayed the advertisement to the user in the form of an advertisement impression. In some embodiments, each publisher may be associated with a weighted value such that at least one publisher may comprise a high weighted value and at least one publisher may comprise a low weighted value. In some embodiments, the weighted value may indicate the influence a publisher may have on a viewer when displaying an advertisement. For example, a first publisher may be associated with a weighted value of ‘2’ to indicate that the advertisement impression on the first publisher may have more of an impact on a user viewing the advertisement. Similarly, a second publisher may be associated with a weighted value of ‘1’ to indicate that the advertisement impression on the second publisher may not have more or an equal impact as the first publisher for impacting a user viewing an advertisement.

As seen in FIG. 6, at block 630, the received publisher identification and the received user state are input to a user behavioral model. As further discussed below, the user behavioral model may capture or predict a user going through a purchase funnel. The user state and/or the publisher identification may be input into the user behavioral model to predict a probability of the user transitioning to another state (e.g., a probability that the user will convert with regard to an advertisement, the user will no longer visit the website, and/or the user will return to an intermediate state where the advertisement will be shown again) as discussed below. At block 640, an effective bid per impression may be calculated. In some embodiments, the effective bid per impression may be calculated based on the advertiser's bid per conversion price and the probability of the user transitioning to another state as predicted from the user behavioral model with user state input. Details with regard to the calculation of an effective bid per impression are discussed below.

### Formalizing a User Behavior Model

In some embodiments, a user behavior model may be formalized to capture a user going through a purchase funnel before purchasing a product. In some embodiments, a purchase funnel may refer to a path of a user before the user performs a conversion (e.g., purchasing a product corresponding to the advertisement) or the user quits as described in further detail below. As such, the conversion probability of an advertisement may depend upon the number of times the advertisement is shown to a particular user. The user behavior model may be used to predict a user's behavior from the perspective of a pay per conversion advertiser A. In some embodiments, there may be T opportunities to show an advertisement to a user, where T may comprise a random variable. For example, T may be assumed to be exponentially distributed such that there may be a fixed drop-out probability (e.g., the user quitting) qε(0,1), and every time a user visits a web page on which an advertisement may be shown, there is a probability q that the user will drop out (e.g., quit) after that and will not come back to another web page. Every time an opportunity to show an ad to this user is presented, a decision may be made whether to show A's advertisement or a competitor's advertisement. For example, in some embodiments, the decision may be made based on the bids of the advertisers. In some embodiments, the value per impression of the competitor's advertisement may be R. In the same or alternative embodiments, R may be the opportunity cost of showing A's advertisement on a web page. R may be assumed to be a random variable and may be independently and identically distributed each time.

In some embodiments, the probability that the user converts (e.g., buys a product from A) may be an arbitrary function of the number of times that the user has seen A's advertisement. Such probability may be denoted by lambda λⱼ, where j is the number of times that the user has seen A's advertisement. In some embodiments, λⱼ may be unimodal, e.g., it increases at the beginning to reach a peak and then decreases.

Advertiser A's value per conversion may be denoted by v. The following section of the disclosure relates to an optimal allocation of advertisement space (to A or the competitor advertiser). For example, the optimal allocation may refer to a bidding agent submitting a per-impression bid on advertiser A's behalf.

### The Advertisement Allocation Problem

Given the values of the parameters of the user behavior model as previously discussed, the goal of the advertisement allocation problem may be to decide when to show A's advertisement to maximize the expected social welfare. In some embodiments, social welfare may be the sum of the values that A and its competitor advertiser derive. In some embodiments, it may be assumed that advertisement space is allocated through a second-price pay-per-impression auction and conversion seeking advertisers like A may participate in the auction through a bidding agent that bids a per-impression value for each auction. The objective of such a bidding agent may be the value to A minus its cost, which is equal to R if A wins. The difference between such objective and the objective of social-welfare maximizing auctioneer may be an additive term equal to the expectation of the sum of the R values.

### MDP Formulation

FIG. 7 illustrates a plurality of user states and transitions between the user states in accordance with some embodiments. In general, a user behavioral model may be used to determine a probability that the user will transition to another state. In some embodiments, a Markov decision processes (MDP) may be defined such that for each j, where j−1 represents the number of advertisement views so far, there may be three states aⱼ, bⱼ, and cⱼ (710, 740, and 760 respectively). The state 710 aⱼ may represent the probabilistic state right before the next time the user views a page on which an advertisement may be displayed. The state 710 aⱼ may have a transition with probability 715 q to the quit state 720 (which may comprise a terminal state), and another with probability 725 1-q to state 740 bⱼ. At state 740 bⱼ, the value of R may be realized and a decision may be made between not showing the advertisement at transition 730, which would give a reward of R and result in a return to the state 710 aⱼ or to show the advertisement at transition 750, which would result in a return to the state 760 cⱼ. As such, bⱼ may be considered an intermediate state where a further transition to another state may be performed. For example, an intermediate state may comprise a state where the advertisement is shown at least one additional time to the user. In some embodiments, the intermediate state may comprise a probability of a user transitioning to a terminal state (e.g., a quit state or a conversion state). This may be a probabilistic state with probability 770 of transition of (1−λⱼ) to state 780 aⱼ+1 (corresponding to the non-conversion event) and probability 790 of transition of λⱼ corresponding to a terminal conversion state 795. The reward of this transition may be v (the value of conversion) plus the value of the infinite sequence of alternative advertisements starting from this point. Since the number of page visits may follow an exponential distribution, the value may be v+(1−q)E[R]/q. The state 710 a₁ may comprise a user starting state.

### The Bellman Equation

The total social welfare obtained from the user starting from the state 740 bⱼ of FIG. 7 may be defined by Vⱼ. At this state 740, a choice may be made between showing a competitor's advertisement or showing A's advertisement. In the former case, a value of R and with probability 1−q will result in being taken back to the state 740 bⱼ. Therefore, the total expected value in this case may be R+(1−q)Vⱼ. In the latter case, with probability λⱼ a conversion occurs, which results in a value of v for the conversion plus (1−q)E[R]/q for the sequence of competitor advertisements that may be shown afterwards. With probability 1−λⱼ, there may be no conversion and the transition may result in the state bⱼ+1 with probability 1−q. Therefore, the expected total value in this case may be λⱼ(v+(1−q)r/q)+(1−λⱼ)(1−q)Vⱼ+1, where r=E[R]. This may be summarized as follows:

The value of Vⱼ of the expected total value starting from the state 740 bⱼ may satisfy the following equation:

$${V}_{j} = {E}_{R} [ max ( R + ( 1 - q ) {V}_{j} , {λ}_{j} ( v + \frac{( 1 - q ) r}{q} ) + ( 1 - {λ}_{j} ) ( 1 - q ) {V}_{j + 1} ) ]$$

In some embodiments, r=E[R]. The value V₁ may indicate the maximum expected welfare in a model.

### Computing the Values

The previously described equation may be simplified to a recurrence relation that may be used to compute Vⱼ. This recurrence may comprise a simple form, but may involve a function that may be non-linear (e.g., depending on distribution of R), and therefore its solution may not be written in a closed form. However, this may be done in the case where R is a constant.

### The General Recurrence

The Bellman equation (for Vⱼ) described above may be simplified in each step and written in terms of a particular function that captures the effect of q and the distribution of R.

First, the Bellman equation may be written in terms of new variables Wⱼ:=(1−q)(Vⱼ−r/q). In some embodiments, Wⱼ may comprise the maximum value starting from the state aⱼ, minus the value starting from this state without the presence of advertiser A. By replacing Vⱼ's by Wⱼ's in Bellman equation (for Vⱼ) described above, the following equation may be obtained:

$$\frac{Wj}{1 - q} = E [ max ( R + {W}_{j} , {λ}_{j} v + ( 1 - {λ}_{j} ) {W}_{j + 1} ) ] - r$$

In some embodiments, the above equation may specify that in the optimal allocation, the advertiser A wins if and only if R+Wⱼ≦λⱼv+(1−λⱼ)Wⱼ₊₁. Thus, in the optimal allocation, at a point where the user has already seen A's advertisement j−1 times, the next impression will be allocated to A if and only if the cost of this impression R is at most the following equation:

λⱼv+(1−λⱼ)Wⱼ₊₁−Wⱼ

The above equation may be rewritten by defining h(x):=E[max(R, x)]. As such, h(x) is a function that only depends on the distribution of R. After subtracting Wⱼ from both sides of the equation for

$$\frac{q Wj}{1 - q} = h ( {λ}_{j} v + ( 1 - {λ}_{j} ) {W}_{j +} - {W}_{j} ) - r$$

the equation may be rewritten as follows:

$$\frac{Wj}{1 - q} ,$$

The above equation may be referred to as equation (3). Note that h is by definition a continuous non-decreasing function. For a value β is ≧0, consider the following equation in terms of the variable x:

qx(1−q)=h(β−x)−r.

At x=0, the right-hand side of the equation is h(β)−r=h(β)−h(0)≧0 and the left-hand side of the equation is zero. At x=β, the right-hand side is h(0)−r=0 and the left-hand side is non-negative. Therefore, since the right-hand side of the equation is non-increasing in x, the left-hand side is strictly increasing, and both sides are continuous functions of x, this equation has a unique solution in [0, β]. The value of this solution may be denoted by u(β).

As such, for any value of q and any distribution of R, the function u(.) may be well-defined, non-decreasing, and continuous. It also satisfies the equation u(β)ε[0, β] for every β.

Note that u(.) may be defined purely in terms of the distribution of R and the value of q, and in fact, it may capture all the information about these parameters that is relevant for the allocation problem. Using this function, equation (3) may be rewritten as follows:

Wⱼ=u(λⱼv+(1−λⱼ)Wⱼ₊₁)

The above equation may be referred to as equation (4). Obtaining an explicit formula for Vⱼ may be possible if u(.) has a simple form. In some embodiments, this function may be complex and non-linear. However, the above equation gives a straightforward way to compute Wⱼ's numerically: start with a large enough j* so that Wⱼ*=0, and then move backward to compute Wⱼ for j=j*−1, . . . , 1. Such a value of j* may exists in most scenarios; for example, any j* such that for all j>j*, λⱼv is less than the minimum of R (say, the value of the reserve price) suffices.

To summarize, the above calculations and Proposition 2 imply the following: Let Wⱼ's be the values computed using the recurrence of equation (4). Then the optimal allocation may be obtained by submitting a per-impression bid of:

bidⱼ:=λⱼv+(1−λⱼ)Wⱼ₊₁−Wⱼ

On behalf of A in a state where the user has already seen the advertisement j−1 times. The social welfare achieved by this mechanism may be r/q+W₁/(1−q).

### Closed-Form Solution for Constant R

In the case that R is a constant r, the recurrence of equation (4) may be simplified. First, note that by definition, h(x)=max(r, x). Therefore, u(β) may be the solution of the equation qx/(1−q)=max(β−x−r, 0). As such, when β≧r, the solution of the above equation is (1−q)(β−r) and when β<r the solution is zero. Therefore, u(β)=(1−q)max(β−r, 0) This gives the following equation:

Wⱼ=(1−q)max(λⱼv−r+(1−λⱼ)Wⱼ₊₁,0)

The above equation may be referred to as equation (5). To solve this recurrence, Wⱼ₊₁ may be expanded in equation (5), and iterative. This may result in the following explicit expression, which can be easily verified by induction using the above recurrence equation (referred to as equation (6)):

Wⱼ=(1−q)max_{l≧j-1}{Σ⊥(s=j)^{†} [symbol] (λ) [symbol] ₛv−r)ψₛ/ψⱼ}

where

$${ψ}_{i} := {\prod }_{i = 1}^{i - 1} ( 1 - q ) ( 1 - λ t )$$

The above equation may be referred to as equation (7). Equation (7) may represent the probability that the user visits at least i times and each time (except possibly the last time) does not convert on A's advertisement.

In equation (7), any empty sum may be defined as zero and an empty product may be defined as one. As such, the final solution may be written as follows:

Vₗ=(r/q)+max_{l≧0}{Σ⊥(s=1)^{†} [symbol] (λ) [symbol] ₛv−r)ψₛ}

The above equation may be referred to as equation (8). As such, let l* be the value of l that achieves the maximum in equation (8). In some embodiments, for the optimal allocation, A's advertisement may be shown until the user converts or the user sees the advertisement l* times. After a conversion happens or this number of advertisement views is reached, the competitor's advertisement may be shown.

IV. Pricing and Publisher Fairness

As described with relation to Section III, an effective bid per impression may be calculated such that a bidding agent may translate the advertiser's A's values into an effective bid per impression every time there is an advertising opportunity. If the advertiser could pay per impression (e.g., a pay-per-impression scenario), this may result that on each auction, the bidding agent may use the pay per impression to bid, and if A wins based on this bid, then A will pay the value of the competitor's bid R. This value would be disbursed to the publisher responsible for that impression. In some embodiments, such a scheme is equivalent to the VCG mechanism from A's perspective (e.g., it allocates the good optimally and charges A the externality she imposes on others), and therefore A has incentive to truthfully report her value per conversion v. Also, the mechanism seems intuitively ‘fair’ for publishers.

However, some advertisers may be strict pay-per-conversion advertisers. For these advertisers, the payment scheme may satisfy the following an Ex-Post Individual Rationality (Ex-Post IR) property. As such, at any outcome where a conversion has not happened, A does not pay anything. At an outcome where a conversion has happened, A pays at most her value per conversion v.

Furthermore, an Efficiency (getting the optimal allocation characterized in the last section) and Incentive Compatibility (IC) may be required. These two properties may imply that in expectation, the amount the advertiser must be charged is the externality it imposes on the others. This is equal to the sum of R on impressions where A's advertisement is shown. In other words, in expectation, the mechanism should charge the same amount as in the pay-per-impression scenario. The challenge is to implement this while respect Ex-Post IR.

As will be further described, this may be achieved with a simple uniform pricing. A natural notion of fairness may be defined in embodiments where there are multiple publishers. There may be instances where the uniform pricing method may not result in a fair distribution of payments to publishers. However, in the case of constant R, the problem may be formulated as a network flow program and a maximum-flow minimum-cut theorem may be used to prove that a fair, ex-post IR and incentive compatible payment rule may exist. As this is a special case of the max-flow min-cut problem, a simpler and faster algorithm for computing the payments may also be generated.

### The Uniform Pricing Method

The idea of the uniform pricing method may be to charge the same amount for all conversions, regardless of how many advertisement impressions A gets prior to the conversion. This uniform cost may set at a level to get the advertiser to pay the right amount in expectation. Using the optimality of the allocation, it may be shown that this scheme satisfies Ex-Post IR. This may first be illustrated in the case of the constant R as follows.

First, note that W₁≧0. This may be seen directly from the definition of W₁ and V₁ as the optimal solution of the MDP or from equation (6). Let l be the value that maximizes equation (8). Thus, following equation may be derived:

Σ⊥(s=1)^{†} [symbol] (λ) [symbol] ₛv−r)ψₛ≧0

Or, equivalently

$$v \geq r \cdot [ ( {\sum }_{i = 1}^{l} {ψ}_{s} ) / ( {{Σ}_{l} ( s = j )}^{†} l ≡ [ ( λ ] {}_{s}^{}{Ψ}{}_{s}^{} ) ]$$

The above equation may be referred to as equation (9). Now consider the expected externality imposed by the advertiser on others. The probability that the advertisement may be shown exactly l times is λᵢψᵢ. For some s<l, the probability that it is shown exactly s times is ψₛ−ψₛ₊ₗ. Therefore, the total expected externality is imposed on others by the advertiser may be defined by the following equation:

$$r {\sum }_{s = 1}^{l} s {ψ}_{{s}^{-}} r {\sum }_{s = 1}^{l - 1} s {ψ}_{s + 1} = r {\sum }_{s = 1}^{l} {ψ}_{s}$$

On the other hand, the probability that the user converts after the i-th view is λᵢψᵢ. Thus, the total probability of conversion is the following equation:

$${\sum }_{s = 1}^{l} λ {}_{s}^{}{Ψ}{}_{s}^{}$$

Therefore, for each conversion, the advertiser may be charged an amount equal to the following equation:

$$r \cdot [ ( {\sum }_{s = 1}^{l} {ψ}_{s} ) / ( {{Σ}_{{ }^{†}} ( s = j )}^{†} l ≡ [ ( λ ] {}_{s}^{}{Ψ}{}_{s}^{} ) ]$$

The expected payment of the advertiser will be equal to the externality it imposes on others (e.g., the IC payment). Also, by equation (9), the payment per conversion may be at most v, and hence Ex-Post IR is also satisfied.

This method may be applied in the general case when R is not a constant. As such, on any conversion, independent of the history of impressions that lead to this conversion, the advertiser may be charged an amount equal to the following equation:

price:=E/P_{conv}

The above equation may be referred to as equation (10). In some embodiments, E is the expected total externality that A imposes on the competitors and P_{conv} is the overall probability of conversion for A. As such, with this charging scheme, in expectation, A pays price×P_{conv}=E, which is the incentive compatible payment. To show that the above price satisfies Ex-Post IR, compare this scenario with the pay-per-impression scenario defined earlier. The outcome in both cases may be the same and A's payment may also be the same in both scenarios in expectation. Therefore, since A's utility in the pay-per-impression scenario is non-negative, it is non-negative here, too, implying that price≦v.

### Publisher Fairness

There may be two main motivations for studying the multiple attribution problem: the first is to ensure the efficiency of the market outcome and the second is to ensure that each advertisement publisher who has contributed in the purchase funnel that has led to a conversion gets a fair share of the conversion price. The following portion of the disclosure discusses fairness among publishers.

First, the notion of fairness for publishers may be defined as each publisher who displays A's advertisement, receives a payment equal to the opportunity cost of this impression. In some embodiments, fairness may be defined in a setting by requiring the same payments in expectation.

For each i, the expected value the i'th impression the publisher receives from A may be equal to the expected opportunity cost R of this publisher conditioned on A winning.

Note that this may be a natural property to require, since it is natural for the publisher to request to be paid an amount at least equal to the opportunity cost of the impressions it provides. If this is not satisfied, then the publisher may refuse to accept pay-per-conversion advertisers. And since the advertiser's payment is the total externality is imposes on the competitors, no publisher may hope to get more than its expected opportunity cost without hurting another publisher.

As will be further described, Publisher Fairness imposes a non-trivial constraint on the payments. In fact, for some payment rules like the uniform scheme defined above, it may not be possible to distribute the payment among the publishers in a way that satisfies Publisher Fairness. To illustrate this and to prepare for the result of the next discussion, consider the case of constant R.

First, number the publishers in the order the user visits advertisement-bearing pages. Let xᵢⱼ be the payout to publisher j if the conversion occurs after i views. This quantity may be defined for i≧j, since for i<j, the user will either never visit publisher j or may visit the publisher after she is already converted. Also, define the variables xᵢⱼ for i, j≦l where l is the index that maximizes the value in equation (8), since after this index, A's advertisement will not be displayed.

The desired properties may be rewritten in terms of the x_{i,j} variables. First, formulate the Publisher Fairness property. For every publisher j=1, . . . l, conditioned the user visiting j, the probability that the user visits exactly i publishers (i≧j) and then it converts may be defined by ψᵢλᵢ/ψⱼ. Thus, the total expected payment to j, conditioned on the user visiting j may be written as the following equation:

$${\sum }_{t \geq J} x {}_{ij}^{}{Ψ}{}_{i}^{} {λ}_{i} / {Ψ}_{j}$$

Therefore the Publisher Fairness property may be written as follows:

$$∀ j \text{:} {\sum }_{i \geq j} {x}_{ij} {ψ}_{i} {λ}_{i} / {ψ}_{j} = r$$

The above equation may be referred to as equation (11). This property may also implies that the payments are incentive compatible: since for each publisher the total payments of A is equal to the externality A imposes on its competitors on this publisher, the total expected payment of A may also equal to the total expected externality it imposes on the competitors. Therefore, all that remains is to formulate the Ex-Post IR property. The total payment of A in case of a conversion happens after precisely i impressions is

$${\sum }_{j \leq i} {x}_{ij} .$$

Therefore, Ex-Post IR is equivalent to the following equation:

$$∀ i \text{:} {\sum }_{j \leq i} {x}_{ij} \leq v$$

The above equation may be referred to as equation (12). Consider the optimal allocation with the uniform pricing rule defined as earlier discussed. There are instances in this mechanism where there is no way to distribute the advertiser's payment among the publishers in a way that satisfies the Publisher Fairness.

For example, consider a situation where λ₁=½, λ₂=¼, and λᵢ=0 for i>2. Also, let q=0, r=1, and v=10. Using equation (8), at these values, the optimal allocation is to display the advertisement l=2 times or until a conversion happens. In expectation, the advertisement will be shown 1+(1−q)(1−λ₁)λ₂=3/2 times, so the expected externality that this advertisement imposes on other advertisements is E=3/2. The probability that a conversion happens in P_{conv}=λ₁+(1−q)(1−λ₁)λ₂=5/8. Therefore, the uniform pricing rule of equation (10) charges a price of E/P_{conv}=2.4 for each conversion. On the other hand, consider the publisher condition of equation (11) for j=2. This condition specifies that x₂₂λ₂=r, and therefore x₂₂=4. This is impossible since x₂₁≧0 and x₂₂+x₂₁ must be equal to the amount the advertiser is charged, i.e., 2.4.

### Fair Payments Via Max-Flow Min-Cut

This section of the disclosure discusses how to show that in the case of constant R, a fair payment rule exists. For example, when R is a constant, the optimal allocation rule can be supplemented with a payment scheme that satisfies the Incentive Compatibility, Ex-Post IR, and Publisher Fairness. For example, the statement may be equivalent to proving that there exists a non-negative matrix [xᵢⱼ] satisfying equation (11) and equation (12). As such, equation (11) may be equivalent to:

$$∀ j \text{:} {\sum }_{i \geq j} {x}_{ij} {Ψ}_{i} {λ}_{i} = r {Ψ}_{j}$$

The above equation may be referred to as equation (13). And equation (12) may be equivalent to:

$$∀ i \text{:} {\sum }_{j \leq i} {x}_{ij} \leq v$$

The above equation may be referred to as equation (14). Now, define another matrix [yᵢⱼ] as yᵢⱼ:=xᵢⱼψᵢλᵢ. The statement may be written in terms of this matrix as follows: There is always a non-negative matrix [yᵢⱼ] satisfying:

$$∀ j \text{:} {\sum }_{i \geq j} {y}_{ij} = r {ψ}_{j}$$

$$and$$

$$∀ i \text{:} {\sum }_{i \leq i} {y}_{ij} \leq v {ψ}_{i} {λ}_{i}$$

The above equations may be referred to as equation (15) and equation (16) respectively. In other words, it may be shown that there is a lower triangular matrix [yᵢⱼ] with prescribed column sums and prescribed upper bounds on the row sums. This may be viewed as a network flow problem in a graph defined as follows: the graph has a source node, a sink node, l nodes corresponding to rows of the matrix and/nodes corresponding to the rows of the matrix. For each 1, there is an infinity-capacity edge from the i'th row vertex to the j'th column vertex for every j≦i. The amount of flow on this edge corresponds to the value of yᵢⱼ. There is an edge from the source to the i'th row vertex with capacity vψᵢλᵢ (indicating the maximum row sum) and a vertex from the j'th column vertex to the sink with capacity rψⱼ (indicating maximum column sum. As such, the existence of the matrix yᵢⱼ corresponds to the existence of a low of value

$${\sum }_{j} r {ψ}_{j}$$

in this network. Therefore, by the max-flow min-cut theorem, it may be shown that the capacity of the minimum cut in this network is at least

$${\sum }_{j} r {ψ}_{j} .$$

Consider a cut in this network and let S (T, correspondingly) denote the set of row (column, correspondingly) vertices that are on the source side of the cut. Since the cut should not contain any infinity-capacity edges, for every j≦max(S), jεT. In other words, it may be denoted {1, . . . , max(S)} by S′, there is S′⊂T and also by definition S⊂S′. The capacity of this cut may be written as the following:

$${\sum }_{i ∈ S} v {ψ}_{i} {λ}_{i} + {\sum }_{j ∈ T} r {ψ}_{j} \geq {\sum }_{i ∈ \dot{S}} v {ψ}_{i} {λ}_{i} + {\sum }_{j ∈ \dot{S}} r {ψ}_{j} = {\sum }_{j} r {ψ}_{j} + {\sum }_{i ∈ \dot{S}} v {ψ}_{i} {λ}_{i} - {\sum }_{j ∈ \dot{S}} r {ψ}_{j}$$

Therefore, to prove the theorem, it is enough to show that for every i,

$${\sum }_{j \geq i} r {ψ}_{j} \leq {\sum }_{j \geq i} v {ψ}_{i} {λ}_{i}$$

The above equation may be referred to as equation (17). Now, recall that by equation (8), l is a value that maximizes the following formula:

Σ⊥(s=1)^{†} [symbol] (λ) [symbol] ₛv−r)ψₛ

In particular, the value of the above expression at l is at least its value at i−1. This proves the inequality of equation (17), thereby completing the proof of the theorem.

The above theorem shows the existence of a payment scheme that satisfies all the properties. It also shows that these payments can be calculated by solving a maximum flow problem. Algorithms for solving the maximum flow problem while having a polynomial running time are relatively complicated and slow. Fortunately, in the case of instant problem, the network is special (corresponding to a lower triangular matrix) and this allows a computation of the optimal flow (and therefore the payments) using a greedy algorithm. The idea of the algorithm is described below.

First, fix the value of y₁₁. This value may be at most min(vψ₁,rψ₁). Without loss of granularity, fix y₁₁ at this maximum. Then, remove this entry, combine the first and the second column (for a total sum of rψ₁+rψ₂−y₁₁) and solve the remaining (l−1)×(l−1) problem. This may work because any solution for the residual problem may be easily transformed into a solution for the l×l problem, since in each row the first and the second entry may be split in any way to get the desired column sums.

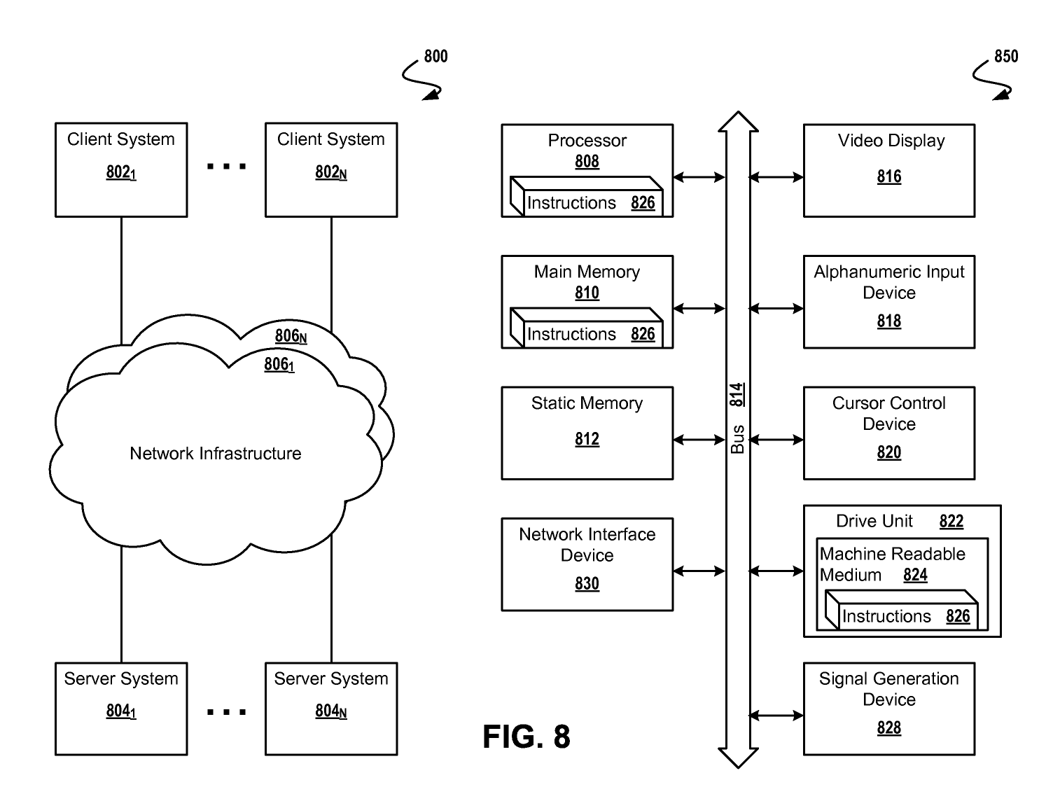

FIG. 8 is a diagrammatic representation of a network 800, including nodes for client computer systems 802₁ through 802_{N}, nodes for server computer systems 804₁ through 804_{N}, nodes for network infrastructure 806₁ through 806_{N}, any of which nodes may comprise a machine 850 within which a set of instructions for causing the machine to perform any one of the techniques discussed above may be executed. The embodiment shown is purely exemplary, and might be implemented in the context of one or more of the figures herein.

Any node of the network 800 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc.).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 850 includes a processor 808 (e.g. a processor core, a microprocessor, a computing device, etc.), a main memory 810 and a static memory 812, which communicate with each other via a bus 814. The machine 850 may further include a display unit 816 that may comprise a touch-screen, or a liquid crystal display (LCD), or a light emitting diode (LED) display, or a cathode ray tube (CRT). As shown, the computer system 850 also includes a human input/output (I/O) device 818 (e.g., a keyboard, an alphanumeric keypad, etc.), a pointing device 820 (e.g., a mouse, a touch screen, etc.), a drive unit 822 (e.g. a disk drive unit, a CD/DVD drive, a tangible computer readable removable media drive, an SSD storage device, etc.), a signal generation device 828 (e.g. a speaker, an audio output, etc.), and a network interface device 1230 (e.g. an Ethernet interface, a wired network interface, a wireless network interface, a propagated signal interface, etc.).

The drive unit 822 includes a machine-readable medium 824 on which is stored a set of instructions (i.e. software, firmware, middleware, etc.) 826 embodying any one, or all, of the methodologies described above. The set of instructions 826 is also shown to reside, completely or at least partially, within the main memory 810 and/or within the processor 808. The set of instructions 826 may further be transmitted or received via the network interface device 830 over the network bus 814.

It is to be understood that embodiments of this disclosure may be used as, or to support, a set of instructions executed upon some form of processing core (such as the CPU of a computer) or otherwise implemented or realized upon or within a machine- or computer-readable medium. A machine-readable medium includes any mechanism for storing information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

1. A method for calculating a bid price for an advertiser to display an advertisement to a user on a website, the method comprising:
receiving, at a computer, an advertising bid from the advertiser, the advertising bid comprising a price per conversion bid for displaying the advertisement on the website;
receiving a user state of the user, the user state comprising a number of times that the user has previously viewed the advertisement;
determining at least one predictive value of the user by using a user behavior model with the user state as an input, the at least one predictive value comprises at least one probability of how the user will respond to the advertisement if the advertisement is displayed; and
calculating an effective bid per impression price based on the at least one predictive value of the user and the price per conversion bid for the advertisement from the advertiser.

2. The method of claim 1, wherein the user state further comprises an identification of the publisher of the website and a weighted value assigned to the publisher of the website such that a higher weighted value results in a higher predictive value than a lower weighted value.

3. The method of claim 1, wherein the user state further comprises demographic information of the user and geographical information of the user.

4. The method of claim 1, wherein the probability of how the user will respond to the advertisement comprises a likelihood of the user transitioning to a state comprising at least one of a quit state and a conversion state, the quit state comprising a terminal state where the user will not convert with regard to the display of the advertisement and the conversion state comprising a terminal state where the user will convert with regard to the display of the advertisement.

5. The method of claim 4, wherein the likelihood of the user transitioning to a state further comprises an intermediary state of displaying the advertisement to the user at another time and determining a probability of the user transitioning from the intermediary state to the conversion state.

6. The method of claim 1, wherein the user state further comprises a path of the user, the path comprises online behavior of the user.

7. The method of claim 1, further comprising submitting the calculated effective bid per impression on behalf of the advertiser to a publisher of the website.

8. A non-transitory computer readable medium carrying one or more instructions for calculating a bid price for an advertiser to display an advertisement to a user on a website, wherein the one or more instructions, when executed by one or more processors, causes the one or more processors to perform the steps of:
receiving an advertising bid from the advertiser, the advertising bid comprising a price per conversion bid for displaying the advertisement on the website;
receiving a user state of the user, the user state comprising a number of times that the user has previously viewed the advertisement;
determining at least one predictive value of the user by using a user behavior model with the user state as an input, the at least one predictive value comprises at least one probability of how the user will respond to the advertisement if the advertisement is displayed; and
calculating an effective bid per impression price based on the at least one predictive value of the user and the price per conversion bid for the advertisement from the advertiser.

9. The non-transitory computer readable medium of claim 8, wherein the user state further comprises an identification of the publisher of the website and a weighted value assigned to the publisher of the website such that a higher weighted value results in a higher predictive value than a lower weighted value.

10. The non-transitory computer readable medium of claim 8, wherein the user state further comprises demographic information of the user and geographical information of the user.

11. The non-transitory computer readable medium of claim 8, wherein the probability of how the user will respond to the advertisement comprises a likelihood of the user transitioning to a state comprising at least one of a quit state and a conversion state, the quit state comprising a terminal state where the user will not convert with regard to the display of the advertisement and the conversion state comprising a terminal state where the user will convert with regard to the display of the advertisement.

12. The non-transitory computer readable medium of claim 11, wherein the likelihood of the user transitioning to a state further comprises an intermediary state of displaying the advertisement to the user at another time and determining a probability of the user transitioning from the intermediary state to the conversion state.

13. The non-transitory computer readable medium of claim 8, wherein the user state further comprises a path of the user, the path comprises online behavior of the user.

14. The non-transitory computer readable medium of claim 8, wherein the steps further comprise submitting the calculated effective bid per impression on behalf of the advertiser to a publisher of the website.

15. A system, comprising at least one processor and memory, for calculating a bid price for an advertiser to display an advertisement to a user on a website, the system comprising:
a module for receiving an advertising bid from the advertiser, the advertising bid comprising a price per conversion bid for displaying the advertisement on the website;
a module for receiving a user state of the user, the user state comprising a number of times that the user has previously viewed the advertisement;
a module for determining at least one predictive value of the user by using a user behavior model with the user state as an input, the at least one predictive value comprises at least one probability of how the user will respond to the advertisement if the advertisement is displayed; and
a module for calculating an effective bid per impression price based on the at least one predictive value of the user and the price per conversion bid for the advertisement from the advertiser.

16. The system of claim 15, wherein the user state further comprises an identification of the publisher of the website and a weighted value assigned to the publisher of the website such that a higher weighted value results in a higher predictive value than a lower weighted value.

17. The system of claim 15, wherein the user state further comprises demographic information of the user and geographical information of the user.

18. The system of claim 15, wherein the probability of how the user will respond to the advertisement comprises a likelihood of the user transitioning to a state comprising at least one of a quit state and a conversion state, the quit state comprising a terminal state where the user will not convert with regard to the display of the advertisement and the conversion state comprising a terminal state where the user will convert with regard to the display of the advertisement.

19. The system of claim 18, wherein the likelihood of the user transitioning to a state further comprises an intermediary state of displaying the advertisement to the user at another time and determining a probability of the user transitioning from the intermediary state to the conversion state.

20. The system of claim 15, wherein the user state further comprises a path of the user, the path comprises online behavior of the user.
